(19) United States
(12) Patent Application Publication
(10) Pub. No.: US 2026/0215405 A1
(43) Pub. Date: Jul. 30, 2026

(54) REEL SEAT

(71) Applicant: GLOBERIDE, Inc., Higashikurume-shi, Tokyo (JP)

(72) Inventors: Masaru AKIBA, Higashikurume-shi (JP); Kosuke USHINOHAMA, Higashikurume-shi (JP)

(73) Assignee: GLOBERIDE, Inc., Higashikurume-shi, Tokyo (JP)

(21) Appl. No.: 19/144,572

(22) PCT Filed: Nov. 16, 2023
(86) PCT No.: PCT/JP2023/041291

§ 371 Date: Jun. 30, 2025

(30) Foreign Application Priority Data
Mar. 14, 2023 (JP) 2023-039203

(51) Int. Cl. A01K 87/06

(52) U.S. Cl. CPC A01K 87/06

(57) ABSTRACT

A reel seat wherein a reel leg of a fishing reel is detachably fixed includes reel seat main body including fixed hood wherein one end side of reel leg is inserted; movable hood that is formed to be movable in axial direction with respect to fixed hood and wherein other end of reel leg is inserted; placement portion wherein back surface of reel leg faces; and tip receiving seat continuous with or separated from placement portion, and extends in width direction at position corresponding to movable hood to be in contact with other end of reel leg in width direction or to be in contact both side portions of other end of reel leg, wherein other end of reel leg is clamped by upper portion of inner peripheral surface of movable hood and tip receiving seat.

### CROSS REFERENCE

The present application claims priority based on Japanese Patent Application No. 2023-039203 (filed on Mar. 14, 2023), the contents of which are incorporated herein by reference in their entirety.

### TECHNICAL FIELD

The present invention relates to a reel seat provided on a fishing rod.

### BACKGROUND ART

For example, Patent Literature 1 discloses a reel seat to which a reel leg of a fishing reel is detachably fixed.

### CITATION LIST

### Patent Literature

Patent Literature 1: JP 2018-113899 A

### SUMMARY OF INVENTION

### Technical Problem

Since a fixed hood side is integrally formed with a reel seat main body, a contact portion with a reel leg can be easily secured, and the reel leg can be stably held. However, on a movable hood side, since the reel leg is clamped between two members of the reel seat main body and the movable hood, there is a tendency for attachment play to occur more easily. For example, in the reel seat of Patent Literature 1, since the reel leg is held by pressing a tip of the reel leg against a depth side of the movable hood, there is a risk that attachment play (particularly play in a left-right direction) may occur even in a case where the movable hood is tightened.

The present invention has been made to solve the above problems, and an object thereof is to provide a reel seat in which attachment play is less likely to occur.

### Solution to Problem

In order to solve the problems, an aspect of the present invention is a reel seat to which a reel leg of a fishing reel is detachably fixed, the reel seat comprising a reel seat main body that comprises a fixed hood to which one end of the reel leg is inserted; a movable hood that is formed to be movable in an axial direction with respect to the fixed hood and to which the other end of the reel leg is inserted; a placement portion that a back surface of the reel leg faces; and a tip receiving seat that is continuous with or separated from the placement portion, and that extends in a width direction at a position corresponding to the movable hood to be in contact with the other end of the reel leg in the width direction or to be in contact with both side portions of the other end of the reel leg, in which the other end of the reel leg is clamped by an upper portion of an inner peripheral surface of the movable hood and the tip receiving seat.

According to the present invention, since the tip receiving seat extending in the width direction and the other end of the reel leg are in contact with each other, attachment play is less likely to occur.

In addition, it is preferable that the tip receiving seat is in line contact or surface contact with both side portions of the other end of the reel leg in the width direction.

In addition, it is preferable that the tip receiving seat is in line contact or surface contact with the other end of the reel leg over the width direction.

According to the present invention, it is possible to further prevent occurrence of attachment play.

In addition, it is preferable that the upper portion of the inner peripheral surface of the movable hood is provided with a first recess portion to which the other end of the reel leg is inserted, and a second recess portion that is formed to be recessed continuously with a depth side of the first recess portion and in which the tip receiving seat is accommodated when the movable hood is tightened.

According to the present invention, by the second recess portion, it is possible to avoid the contact between the movable hood and the tip receiving seat when the movable hood is tightened.

### Advantageous Effects of Invention

According to the present invention, it is possible to provide a reel seat in which attachment play is less likely to occur.

### BRIEF DESCRIPTION OF DRAWINGS FIG. 1 is a side sectional view illustrating a reel seat and a fishing reel according to a first attachment mode.

FIG. 2 is a side sectional view illustrating the reel seat according to the first attachment mode.

FIG. 3 is a plan view illustrating a reel seat main body according to the first attachment mode.

FIG. 4 is a view taken along line IV-IV of FIG. 3.

FIG. 5 is a sectional view illustrating a movable hood according to the first attachment mode.

FIG. 6 is a rear view illustrating the movable hood according to the first attachment mode.

FIG. 7 is a perspective view illustrating the movable hood according to the first attachment mode.

FIG. 8A is a perspective view illustrating a vicinity of a tip receiving seat according to the first attachment mode.

FIG. 8B is a perspective view illustrating a periphery of the tip receiving seat and the other end of a reel leg according to the first attachment mode.

FIG. 9 is a view illustrating a contact state in a case where the reel leg according to the first attachment mode is viewed from a side.

FIG. 10 is a view illustrating a contact state with the tip receiving seat in a case where the reel leg according to the first attachment mode is viewed from a back side.

FIG. 11 is a view illustrating a contact state with the movable hood in a case where the reel leg according to the first attachment mode is viewed from a front side.

FIG. 12 is a side sectional view illustrating a reel seat and a fishing reel according to a second attachment mode.

FIG. 13 is a view illustrating a contact state in a case where a reel leg according to the second attachment mode is viewed from a side.

FIG. 14 is a view illustrating a contact state with a tip receiving seat in a case where the reel leg according to the second attachment mode is viewed from a back side.

FIG. 15 is a view illustrating a contact state with a movable hood in a case where the reel leg according to the second attachment mode is viewed from a front side.

### DESCRIPTION OF EMBODIMENTS

### First Attachment Mode

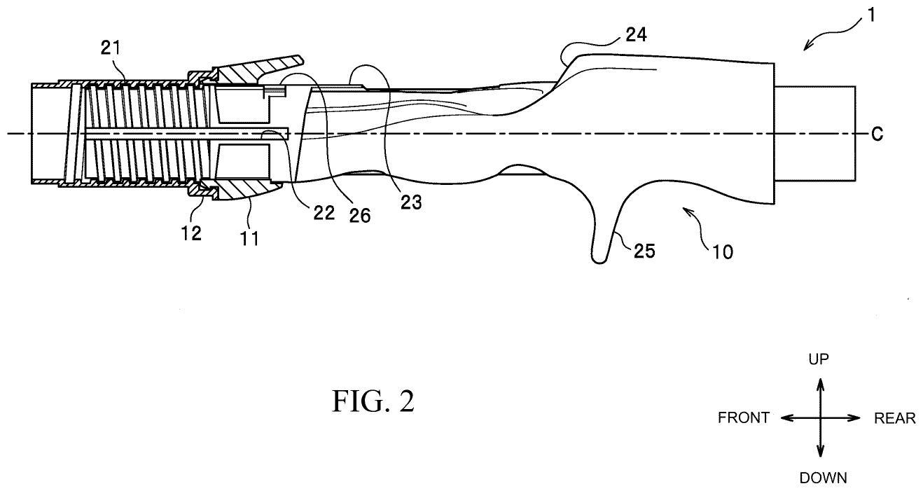

Hereinafter, a reel seat according to embodiments of the present invention will be described with reference to the drawings. In the embodiments, the same portions are denoted by the same reference numerals, and redundant description will be omitted. Note that “up and down”, “left and right”, and “front and rear” follow arrows in FIGS. 1 and 3. A rod tip side is “front”, and a rod base side is “rear”.

As illustrated in FIG. 1, a reel seat 1 according to the present embodiment is a tubular member configured to detachably fix a fishing reel R. The fishing reel R comprises a reel main body R1 and a reel leg R2. The reel main body R1 comprises a spool, a handle, and the like, and is a device that releases or winds up a fishing line in response to a user's operation. The fishing reel R is exemplified by a dual-axis reel (baitcasting reel) in the present embodiment, but may be a fishing spinning reel.

The reel leg R2 is a plate-shaped portion provided in a lower portion of the reel main body R1. The reel leg R2 is made of metal, and comprises a base body portion R3, one end R4, and the other end R5. The reel leg R2 is slightly curved to be convex upward over the entire extension direction in a case of being viewed along a front-rear direction axis. The base body portion R3 is substantially parallel to a shaft center C of the reel seat 1 when viewed from the side. On the other hand, in the reel leg R2 of the present embodiment, the one end R4 is slightly inclined downward with respect to base body portion R3, and the other end R5 is also slightly inclined downward with respect to the base body portion R3.

The reel leg R2 may be formed with a rigid structure using a lightweight material, such as a metal including aluminum alloy, titanium alloy, or magnesium alloy; a high-strength resin such as ABS resin or PA resin; or a fiber-reinforced resin such as CFRP or GFRP.

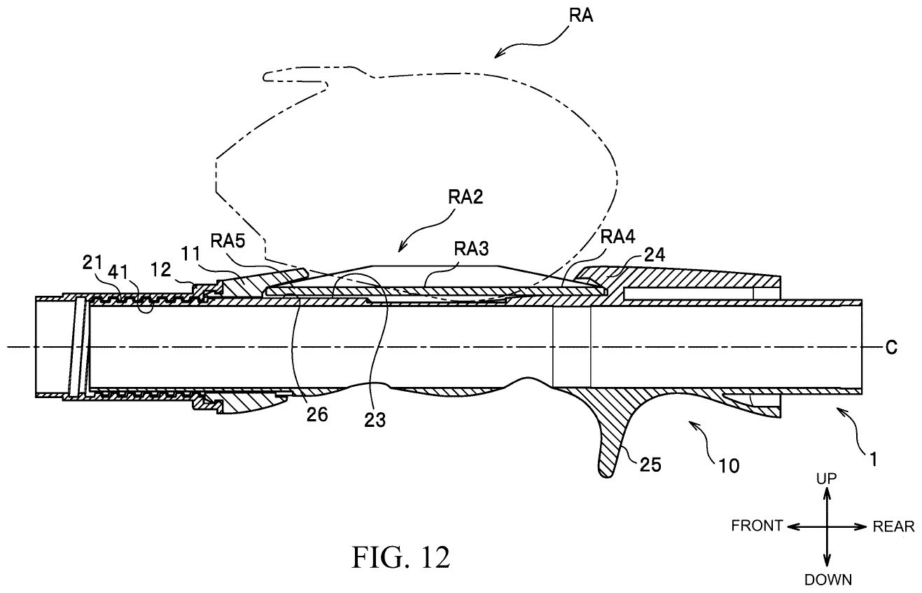

Note that in the present embodiment, a case where the fishing reel R illustrated in FIGS. 1 to 11 and a fishing reel RA illustrated in FIGS. 12 to 15 are attached to the same reel seat 1 will be described as an example. These fishing reels R and RA are different in shapes of the reel legs R2 and RA2. A mode in which the fishing reel R is attached is referred to as a “first attachment mode”, and a mode in which the fishing reel RA is attached is referred to as a “second attachment mode”.

The reel seat 1 is a resin member to which the reel leg R2 of the fishing reel R is fixed. A rod (not illustrated) is inserted into a hollow portion of the reel seat 1 and fixed with an adhesive. The reel seat 1 comprises a reel seat main body 10, a movable hood 11, and an operation knob 12.

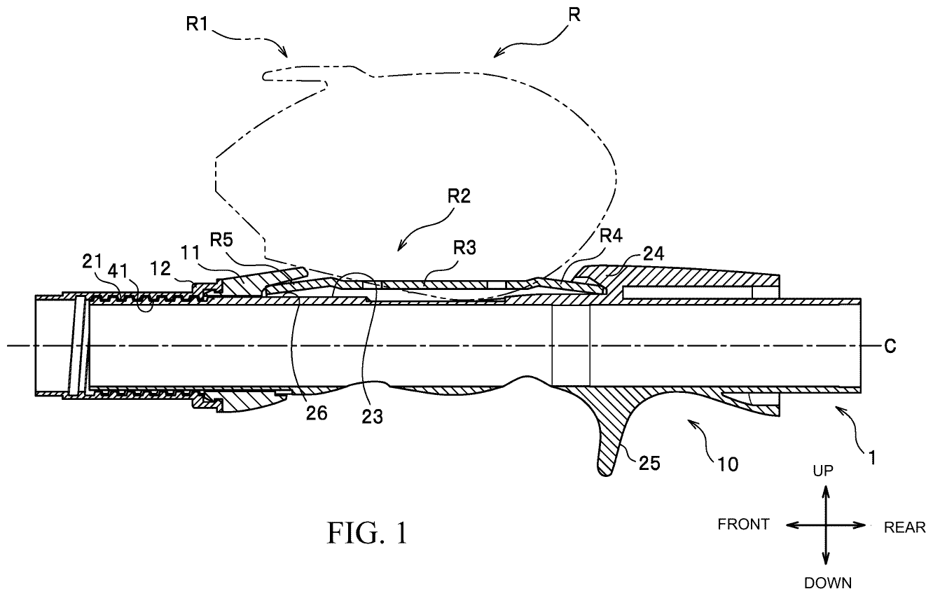

As illustrated in FIG. 2, the reel seat main body 10 has a tubular shape and comprises a hollow portion into which the rod is inserted. The reel seat main body 10 comprises a male screw portion 21, a guide groove 22, a placement portion 23, a fixed hood 24, a trigger 25, and a tip receiving seat 26.

The male screw portion 21 is formed on an outer peripheral surface of a front end of the reel seat main body 10. The male screw portion 21 is a part where the operation knob 12 is rotated. A plurality of guide grooves 22 is formed to extend rearward from the male screw portion 21. The guide groove 22 is a groove that guides the movable hood 11 in an axial direction. As illustrated in FIGS. 1 to 3, the placement portion 23 is a part formed in a substantially flat shape along the front-rear direction in the upper portion of the reel seat main body 10. The placement portion 23 is a part where a back surface of the reel leg R2 faces or comes into contact with.

The fixed hood 24 is formed at the upper portion on the rear side of the reel seat main body 10 and is a hole with its front side open. The fixed hood 24 is a part to which the one end R4 of the reel leg R2 is inserted. The trigger 25 is formed at the lower portion on the rear side of the reel seat main body 10 to protrude downward.

The trigger 25 is a part that engages the user's finger. The trigger 25 may be omitted.

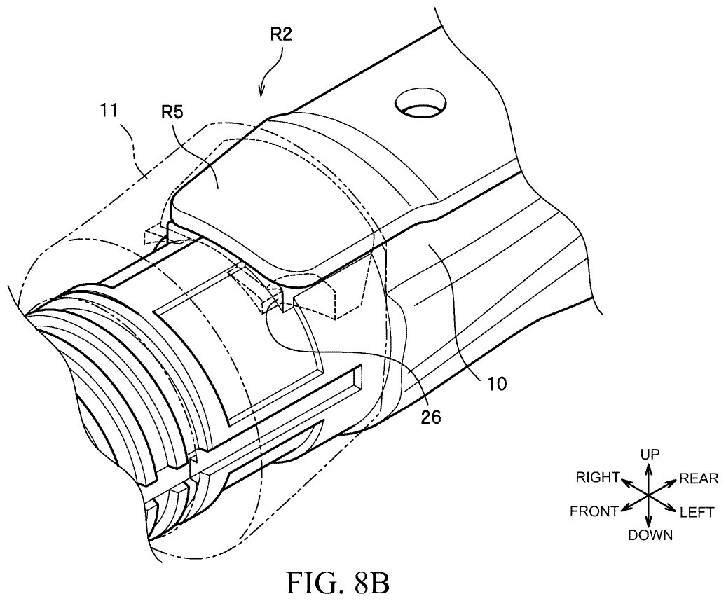

As illustrated in FIGS. 3, 4, and 8A, the tip receiving seat 26 is a part that is formed on the front side of the placement portion 23 to be separated from the placement portion 23 and where the other end R5 of the reel leg R2 is placed. The tip receiving seat 26 is disposed to be positioned inside the movable hood 11 in a state where the movable hood 11 is tightened (refer to FIG. 1). As illustrated in FIG. 8A, the tip receiving seat 26 is formed at the upper portion of the outer peripheral surface of the reel seat main body 10. The tip receiving seat 26 extends in a width direction (left-right direction in the drawing) and has a rectangular shape in plan view. The width of the tip receiving seat 26 is substantially equal to the width of the other end R5 of the reel leg R2. In addition, the length of the tip receiving seat 26 in a shaft center C direction may be about 3 to 10 mm as long as the other end R5 of the reel leg R2 is placed.

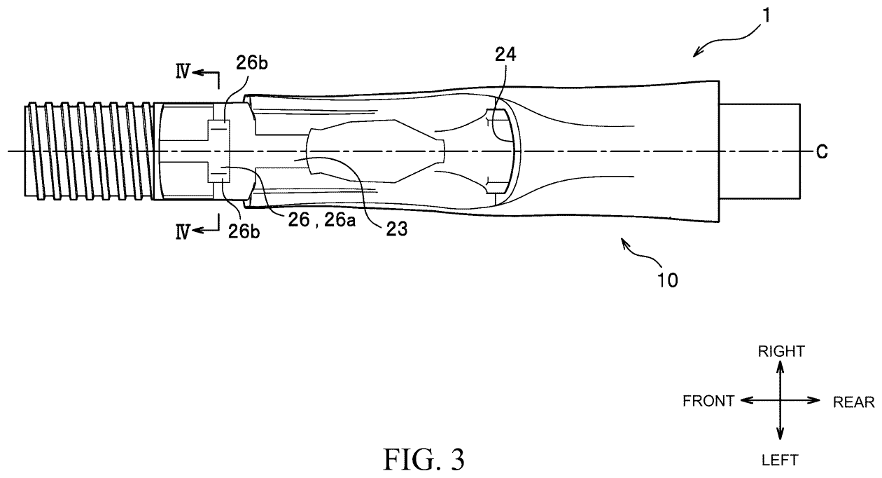

As illustrated in FIG. 4, the tip receiving seat 26 comprises a central portion 26a, side portions 26b and 26b, and side walls 26c and 26c. The central portion 26a is slightly curved in an arc shape to be convex upward in a case of being viewed from the front-rear direction axis. The side portion 26b is an inclined surface slightly inclined so that the central portion 26a side becomes higher. The side wall 26c is continuous with the side portion 26b and is formed upright in an up-down direction from the outer peripheral surface of the reel seat main body 10.

Note that the entire tip receiving seat 26 may be a flat surface or a curved surface, or may be a combination of a flat surface and a curved surface. For example, the side portions 26b and 26b may be flat surfaces (surfaces parallel to a plane including the front-rear direction axis and the left-right direction axis), and the central portion 26a may be curved. The tip receiving seat 26 may be formed continuously with the placement portion 23. In addition, the central portion 26a and the side portions 26b may be separated from each other.

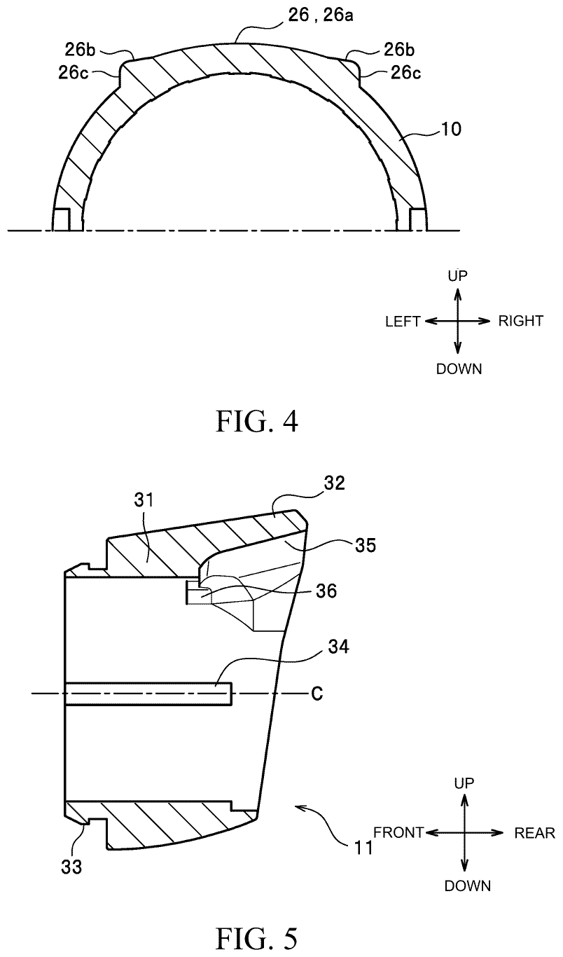

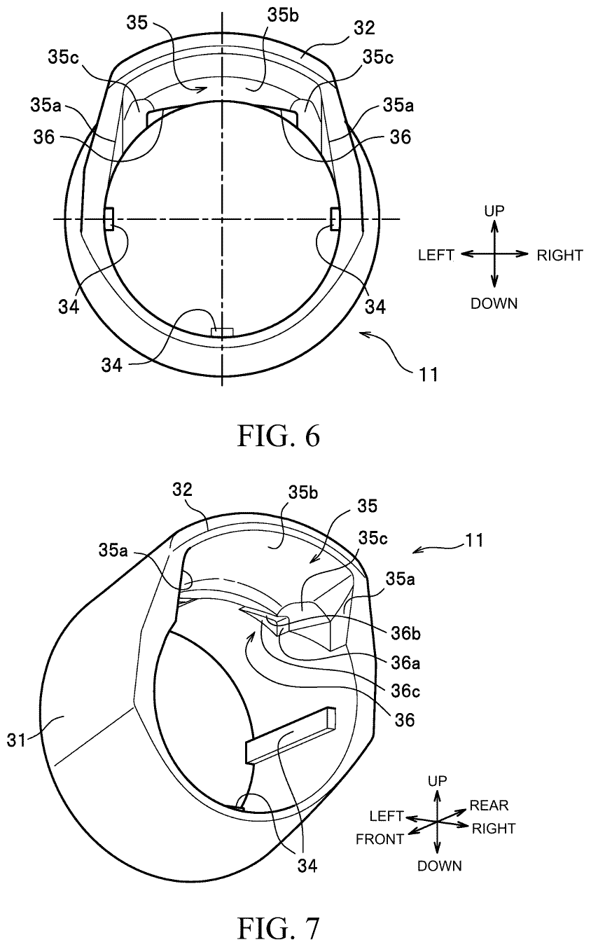

As illustrated in FIG. 2, the movable hood 11 has a tubular shape and is loosely fitted in a part corresponding to the guide groove 22 of the reel seat main body 10. The movable hood 11 is a member that is movable forward and rearward with respect to the reel seat main body 10 and covers the other end R5 of the reel leg R2. As illustrated in FIGS. 5 and 6, the movable hood 11 comprises a main body portion 31, a hood portion 32, an engagement portion 33, and a ridge portion 34. The main body portion 31 is a part having a cylindrical shape. The hood portion 32 is a part extending obliquely upward toward the rear side in an upper half of the main body portion 31.

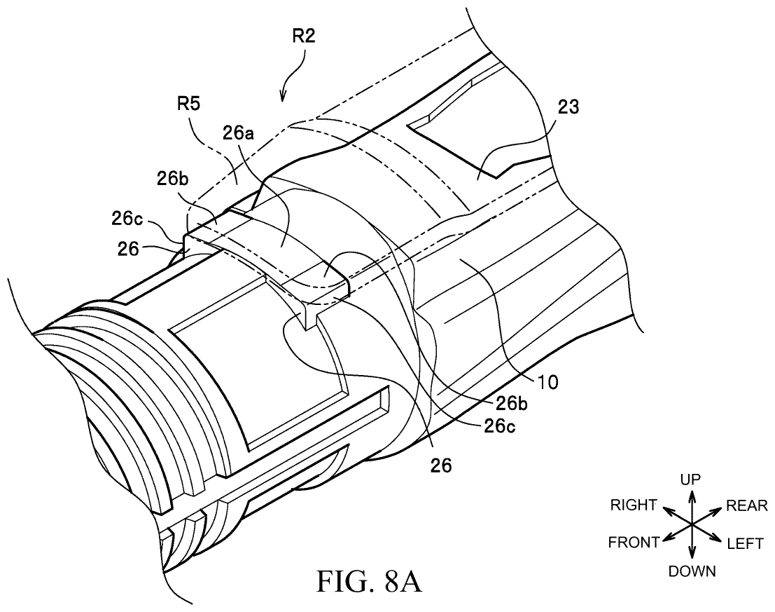

As illustrated in FIGS. 6 and 7, a first recess portion 35 and second recess portions 36 and 36 are formed at the upper portion of an inner peripheral surface of the hood portion 32. The first recess portion 35 is recessed to receive the other end R5 of the reel leg R2. The second recess portion 36 is sufficiently smaller than the first recess portion 35, continues to the depth side of the first recess portion 35, and is formed to be recessed upward.

The second recess portion 36 is a part where the tip receiving seat 26 is accommodated when the movable hood 11 is tightened without the reel leg R2. As a result, interference between the tip receiving seat 26 and the movable hood 11 can be avoided. The second recess portion 36 is narrower than the first recess portion 35 in the width direction. In addition, the length of the second recess portion 36 in the shaft center C direction is sufficiently smaller than the length of the first recess portion 35.

As illustrated in FIG. 7, the first recess portion 35 comprises first side surfaces 35a and 35a, an upper surface 35b, and second side surfaces 35c and 35c. The first side surface 35a is formed upright on both left and right sides. The upper surface 35b is curved to be convex upward, and is inclined obliquely downward toward the front side (depth side). The second side surfaces 35c are provided as a pair on both left and right sides, and is a surface inclined obliquely from the first side surface 35a to the second recess portion 36.

The second recess portions 36 are provided as a pair on the left and right sides, on the depth side of the first recess portion 35. The second recess portion 36 comprises a side surface 36a, an upper surface 36b, and an end surface 36c. The side surface 36a is substantially parallel to the side surface 35a of the first recess portion 35. The upper surface 36b is substantially parallel to the placement portion 23. The upper surface 36b may be inclined obliquely downward as the upper surface 36b extends toward the front side (depth side). The end surface 36c extends downward from the upper surface 36b.

As illustrated in FIG. 5, the engagement portion 33 is a part rotatably engaged with the operation knob 12 (refer to FIG. 1). The ridge portion 34 protrudes from the inner peripheral surface of the main body portion 31 and extends in the shaft center C direction. The ridge portion 34 is a part that slides within the guide groove 22 of the reel seat main body 10.

As illustrated in FIG. 1, the operation knob 12 is connected to the front side of the movable hood 11 and has a tubular shape. The operation knob 12 is connected to the movable hood 11 so as to be relatively rotatable with respect to the movable hood 11. The operation knob 12 is a member that moves the movable hood 11 along the axial direction. A female screw portion 41 is formed on the inner peripheral surface of the operation knob 12.

When the operation knob 12 is rotated in a circumferential direction, the operation knob 12 is moved in the axial direction while being rotated in the front-rear direction by the screwing engagement between the male screw portion 21 and the female screw portion 41, and the movable hood 11 is also moved in the axial direction following the operation knob 12. By moving the position of the movable hood 11 in the front-rear direction relative to the fixed hood 24, the reel leg R2 can be fixed or released.

Next, a clamped state (contact state) of the other end R5 of the reel leg R2 with the movable hood 11 and the tip receiving seat 26 according to the first attachment mode will be described. As illustrated in FIGS. 8A and 8B, when the other end R5 of the reel leg R2 is placed on the tip receiving seat 26 and the operation knob 12 is rotated, the other end R5 is clamped in the up-down direction by the movable hood 11 and the tip receiving seat 26.

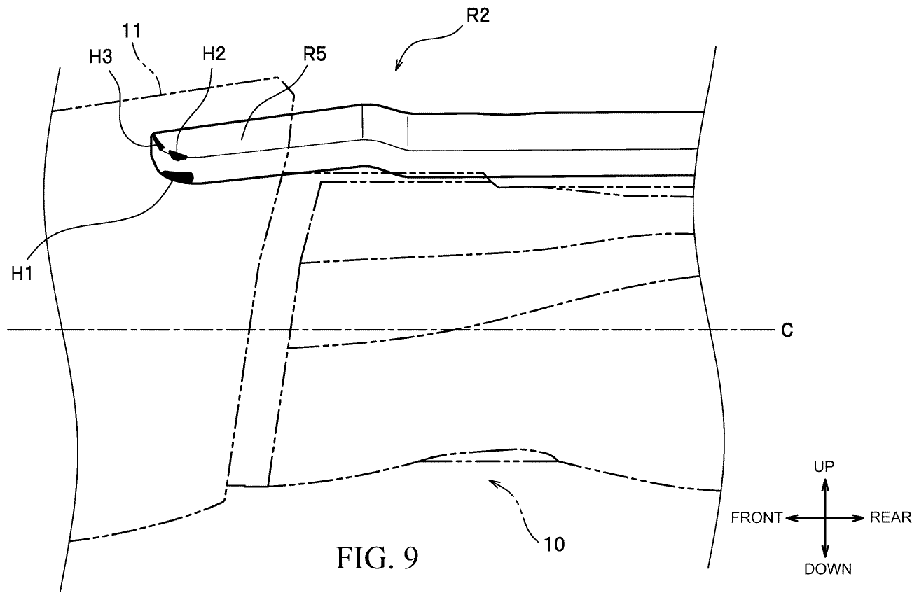

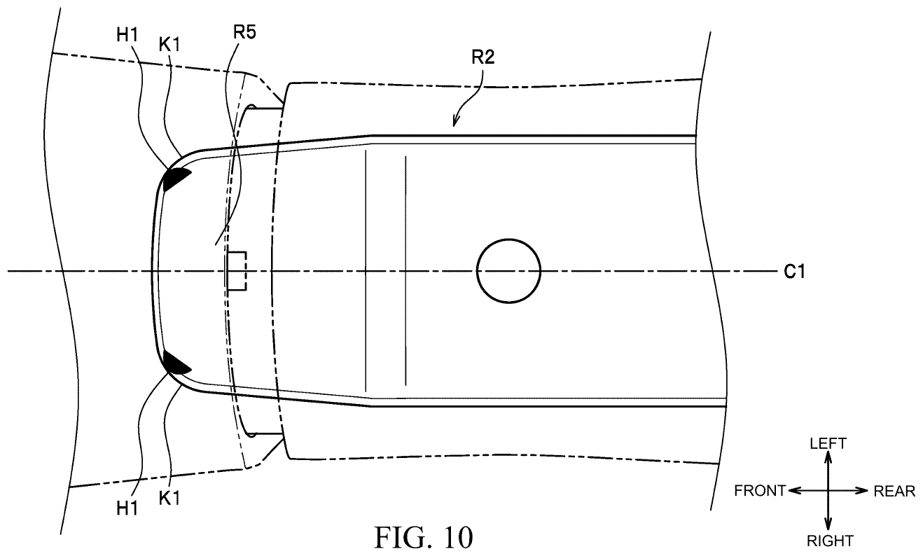

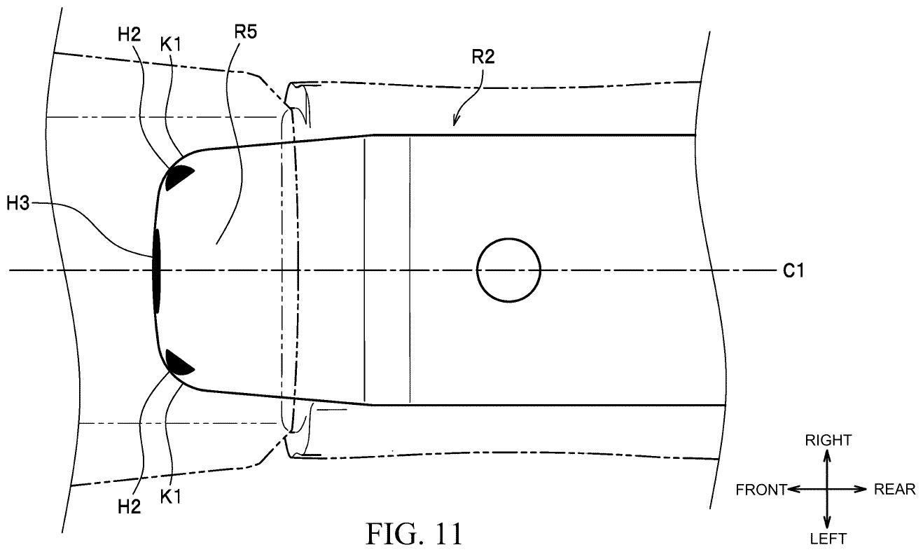

FIG. 9 is a view illustrating a contact state in a case where the reel leg according to the first attachment mode is viewed from a side. FIG. 10 is a view illustrating a contact state with the tip receiving seat in a case where the reel leg according to the first attachment mode is viewed from a back side. FIG. 11 is a view illustrating a contact state with the movable hood in a case where the reel leg according to the first attachment mode is viewed from a front side. The black-shaded portions in FIGS. 9 to 11 indicate the respective contact regions of the other end R5 of the reel leg R2 with the movable hood 11 and the tip receiving seat 26.

As illustrated in FIG. 10, on the back surface of the other end R5, the vicinity of corner portions K1 and K1 of the other end R5 is in surface contact with the side portions 26b and 26b of the tip receiving seat 26 in contact regions H1 and H1. In other words, both side portions of the back surface of the other end R5 are in surface contact with the tip receiving seat 26. When a line passing through the center of the other end R5 in the width direction is defined as a center line C1, the contact regions H1 and H1 are substantially symmetrical on the left and right sides with respect to the center line C1, and the areas of the contact regions H1 and H1 are also substantially the same.

In addition, as illustrated in FIG. 11, on the front surface (surface on a side opposite to the back surface) of the other end R5, the vicinity of the corner portions K1 and K1 of the other end R5 is in surface contact with the movable hood 11 in contact regions H2 and H2, respectively. The contact regions H2 and H2 are substantially symmetrical on the left and right sides with respect to the center line C1, and the areas of the contact regions H2 and H2 are also substantially the same. More specifically, the contact region H2 is a region where the other end R5 is in contact with the depth side (refer to FIG. 7) of the upper surface 35b of the first recess portion 35.

In addition, on the front surface of the other end R5, the central portion of the tip is in line contact with the movable hood 11 in a contact region H3. In other words, the tip of the other end R5 is in line contact with the movable hood 11 substantially symmetrical on the left and right sides across both sides in the width direction with respect to the center line C1. More specifically, the contact region H3 is a region where the tip of the other end R5 is in contact with the depth side (refer to FIG. 7) of the upper surface 35b of the first recess portion 35 by tightening the movable hood 11.

Note that as illustrated in FIG. 1, the tip of the one end R4 of the reel leg R2 is in line contact with the depth side of the fixed hood 24 over the left-right direction.

The contact state between the one end R4 and the fixed hood 24 is not particularly limited, but it is preferable that point contact, line contact, or surface contact is made on both sides in the left-right direction such that the attachment play does not occur. In addition, the one end R4 and the fixed hood 24 may be in line contact or surface contact with each other over the left-right direction.

With the reel seat 1 according to the present embodiment described above, while the other end R5 of the reel leg R2 is clamped between the tip receiving seat 26 and the upper portion of the inner peripheral surface of the movable hood 11, the tip receiving seat 26 is in surface contact with the back surface of the other end R5 of the reel leg R2, and thus the attachment play is less likely to occur. More specifically, in the present embodiment, as illustrated in FIG. 10, the tip receiving seat 26 is in surface contact with both sides of the other end R5 of the reel leg R2 in the width direction in the contact regions H1 and H1. As a result, the contact is made on both sides in the width direction and symmetrically on the left and right sides, and hence, it is possible to prevent the occurrence of the attachment play.

In addition, according to the present embodiment, while the other end R5 is received by the first recess portion 35, the upper surface 35b and the other end R5 are in surface contact in the contact regions H2 and H2 (refer to FIG. 11). As a result, the contact is made on both sides in the width direction and symmetrically on the left and right sides, and hence, it is possible to further prevent the occurrence of the attachment play. In addition, since the contact regions H1 and H2 can perform the clamp at substantially the same position in the up-down direction, it is possible to stably perform the fixation.

In addition, since the upper surface 35b of the first recess portion 35 and the tip of the other end R5 of the reel leg R2 are in line contact over the width direction in the contact region H3, it is possible to further prevent the occurrence of the attachment play. Since the contact region H3 is symmetrical on the left and right sides with respect to the center line C1, it is possible to perform the holding in a well-balanced manner. In addition, the contact also occurs in the contact region H3 in addition to the contact regions H2 and H2, it is possible to synergistically prevent the occurrence of the attachment play. In addition, the contact region H3 allows the other end R5 to be pushed toward the fixed hood 24 from the front side when the movable hood 11 is tightened. As a result, it is possible to further prevent the occurrence of the attachment play.

Note that in the present embodiment, the surface contact is made in the contact regions H1 and H2, but substantially the same effect can be obtained even in the case of point contact or line contact. In addition, the contact regions H1 and H1 and the contact regions H2 and H2 do not necessarily have to be symmetrical on the left and right sides or do not necessarily have the same area. In addition, the contact region H3 is not necessarily symmetrical on the left and right sides with respect to the center line C1. In addition, although not specifically illustrated, the tip receiving seat 26 and the other end R5 may be in line contact or surface contact (continuously in the width direction) over the width direction.

### Second Attachment Mode

Next, a second attachment mode of the present embodiment will be described. As described above, the reel seat 1 of the second attachment mode is the same as that of the first attachment mode, but the shape of the reel leg RA2 of the fishing reel RA is different from that of the first attachment mode.

As illustrated in FIG. 12, the present embodiment is different from the first attachment mode in that the reel leg RA2 of the fishing reel RA is linear over the entire shaft center C direction. That is, the reel leg RA2 is substantially parallel to the placement portion 23. When the fishing reel RA is fixed to the reel seat 1, one end RA4 of the reel leg RA2 is inserted into the fixed hood 24, and the other end RA5 is inserted into the movable hood 11. When the other end RA5 is placed on the tip receiving seat 26 and the operation knob 12 is rotated, the other end RA5 is clamped in the up-down direction by the movable hood 11 and the tip receiving seat 26.

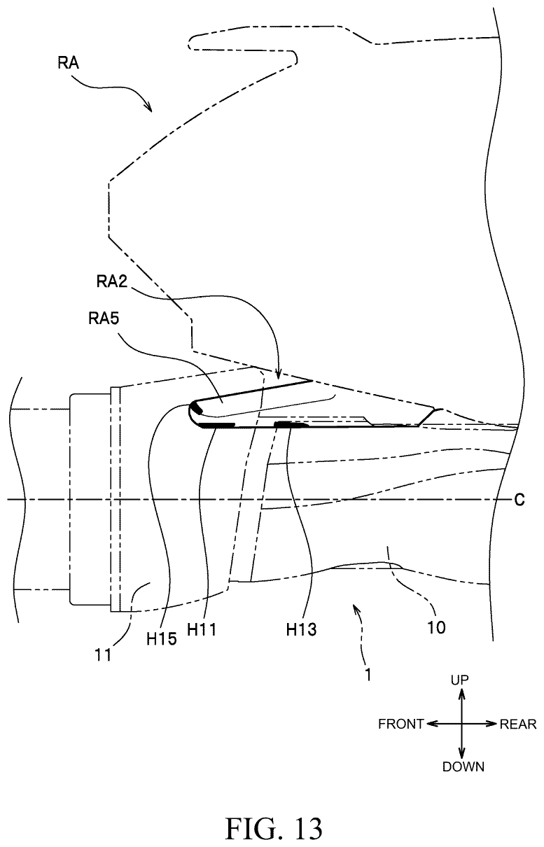

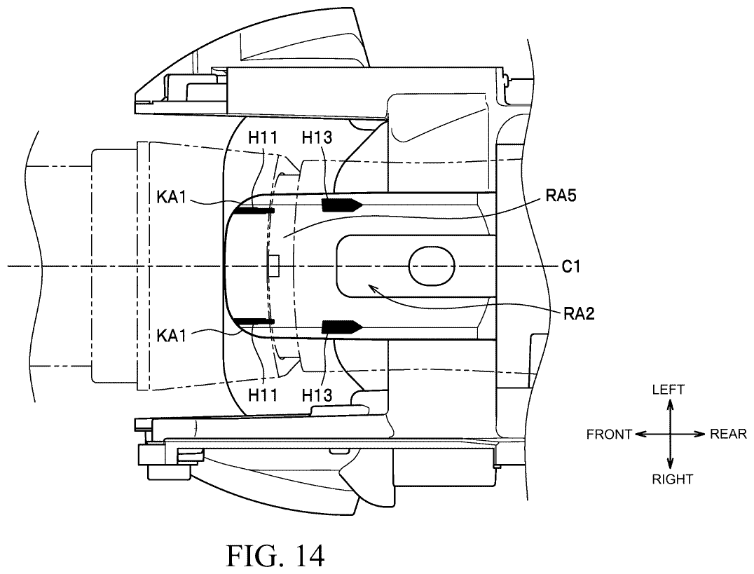

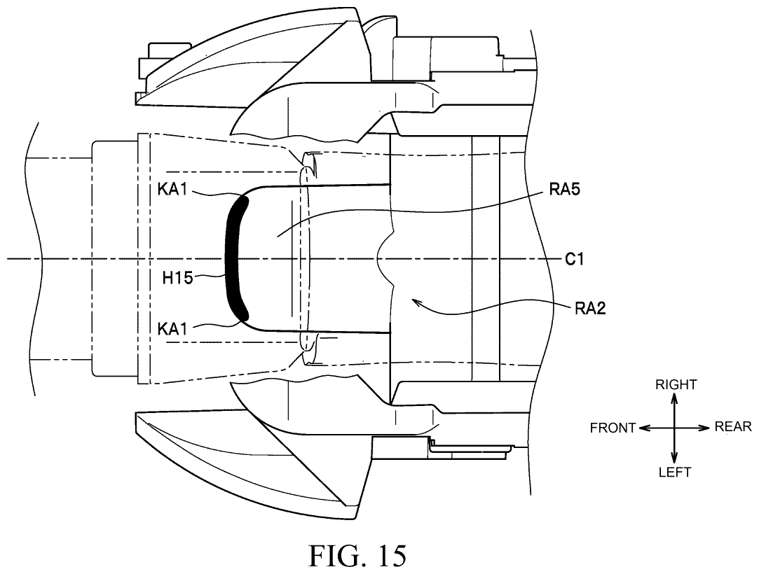

FIG. 13 is a view illustrating a contact state in a case where the reel leg according to the second attachment mode is viewed from the side. FIG. 14 is a view illustrating a contact state with the tip receiving seat in a case where the reel leg according to the second attachment mode is viewed from the back side. FIG. 15 is a view illustrating a contact state with the movable hood in a case where the reel leg according to the second attachment mode is viewed from the front side. The black-shaded portions in FIGS. 13 to 15 indicate the respective contact regions of the other end RA5 of the reel leg RA2 with the movable hood 11 and the tip receiving seat 26.

As illustrated in FIG. 14, on the back surface of the other end RA5, the vicinity of corner portions KA1 and KA1 of the other end RA5 is in line contact with the side portions 26b and 26b of the tip receiving seat 26 in contact regions H11 and H11. In other words, both side portions of the back surface of the other end RA5 are in line contact with the tip receiving seat 26. The contact regions H11 and H11 are substantially symmetrical on the left and right sides with respect to the center line C1, and the contact lengths thereof are also substantially the same.

In addition, on the back surface of the other end RA5, both side portions of the other end RA5 and both side portions of the placement portion 23 are in surface contact with each other in contact regions H13 and H13. The contact regions H13 and H13 are substantially symmetrical on the left and right sides with respect to the center line C1, and the contact lengths thereof are also substantially the same.

In addition, on the front surface of the other end RA5, the tip is in line contact with the movable hood 11 in a contact region H15. In other words, the tip of the other end RA5 is in surface contact with the movable hood 11 substantially symmetrical on the left and right sides across both sides in the width direction with respect to the center line C1. More specifically, the contact region H15 is a region where the tip of the other end RA5 is in contact with the depth side (refer to FIG. 7) of the upper surface 35b of the first recess portion 35 by tightening the movable hood 11.

Note that although not specifically illustrated, the contact state between one end of the reel leg RA2 (end on a side opposite to the other end RA5) and the fixed hood 24 is not particularly limited, but it is preferable that point contact, line contact, or surface contact is made on both sides in the left-right direction such that the attachment play does not occur. In addition, the one end and the fixed hood 24 may be in line contact or surface contact with each other over the left-right direction.

With the reel seat 1 according to the present embodiment described above, as illustrated in FIG. 14, while the other end RA5 of the reel leg RA2 is clamped between the tip receiving seat 26 and the upper portion of the inner peripheral surface of the movable hood 11, the tip receiving seat 26 is in line contact with the back surface of the other end RA5 of the reel leg RA2, and thus the attachment play is less likely to occur. More specifically, in the present embodiment, the tip receiving seat 26 is in line contact with both sides of the other end RA5 of the reel leg RA2 in the width direction in the contact regions H11 and H11. As a result, the contact is made on both sides in the width direction and symmetrically on the left and right sides, and hence, it is possible to prevent the occurrence of the attachment play. In addition, with the reel seat 1, even in a case where the shape of the reel leg viewed from the side is curved as in the first attachment mode or is straight as in the second attachment mode, the clamp can be performed in a well-balanced manner, and the attachment play is less likely to occur.

In addition, since the inner peripheral surface (upper surface 35b) of the movable hood 11 and the front surface of the other end RA5 of the reel leg R2 are in surface contact over the width direction in the contact region H15, it is possible to further prevent the occurrence of the attachment play. In addition, since the contact region H15 is symmetrical on the left and right sides with respect to the center line C1, it is possible to perform the holding in a well-balanced manner. Furthermore, the contact region H15 allows the other end RA5 to be pushed toward the fixed hood 24 from the front side when the movable hood 11 is tightened. As a result, it is possible to further prevent the occurrence of the attachment play.

Note that in the present embodiment, substantially the same effect can be obtained as long as the point contact, line contact or surface contact is made in the contact regions H11 and H13. In addition, the contact regions H11 and H11 and the contact regions H13 and H13 do not necessarily have to be symmetrical on the left and right sides or do not necessarily have the same area. In addition, the contact region H15 is not necessarily symmetrical on the left and right sides with respect to the center line C1. In addition, although not specifically illustrated, the tip receiving seat 26 and the other end RA5 may be in line contact or surface contact (continuously in the width direction) over the width direction.

The embodiments of the reel seat and the attachment structure of the reel seat according to the present invention have been described above, but the design modifications may be made without departing from the spirit of the present invention.

### REFERENCE SIGNS LIST

1 reel seat
10 reel seat main body
11 movable hood
23 placement portion
24 fixed hood
26 tip receiving seat
35 first recess portion
36 second recess portion
R fishing reel
R1 reel main body
R2 reel leg
R3 base body portion
R4 one end
R5 the other end

1. A reel seat to which a reel leg of a fishing reel is detachably fixed, the reel seat comprising:
a reel seat main body comprising a fixed hood to which one end of the reel leg is inserted;
a movable hood that is formed to be movable in an axial direction with respect to the fixed hood and to which the other end of the reel leg is inserted;
a placement portion that a back surface of the reel leg faces; and
a tip receiving seat that is continuous with or separated from the placement portion, and that extends in a width direction at a position corresponding to the movable hood to be in contact with the other end of the reel leg in the width direction or to be in contact with both side portions of the other end of the reel leg, wherein
the other end of the reel leg is clamped by an upper portion of an inner peripheral surface of the movable hood and the tip receiving seat.

2. The reel seat according to claim 1, wherein the tip receiving seat is in line contact or surface contact with both side portions of the other end of the reel leg in the width direction.

3. The reel seat according to claim 1, wherein the tip receiving seat is in line contact or surface contact with the other end of the reel leg over the width direction.

4. The reel seat according to claim 1, wherein the upper portion of the inner peripheral surface of the movable hood is provided with a first recess portion to which the other end of the reel leg is inserted, and a second recess portion that is formed to be recessed continuously with a depth side of the first recess portion and in which the tip receiving seat is accommodated when the movable hood is tightened.
